(19) United States
(12) Patent Application Publication
(10) Pub. No.: US 2018/0043244 A1
(43) Pub. Date: Feb. 15, 2018

(54) Block It Dice Game

(71) Applicant: Kenneth E. Rutan, Des Moines, IA (US)

(72) Inventor: Kenneth E. Rutan, Des Moines, IA (US)

(21) Appl. No.: 15/603,697

(22) Filed: May 24, 2017

Related U.S. Application Data
(60) Provisional application No. 62/374,405, filed on Aug. 12, 2016.

(51) Int. Cl. A63F 9/04; G09B 19/22

(52) U.S. Cl. CPC A63F 9/0415; G09B 19/22

(57) ABSTRACT

The invention as outlined provides a dice game for both indoor and outdoor use. The dice game comprises rules and three dice, two standard dice with six sides comprised of black pips denoting numbers 1-6, and a third die known as the Block It die (“Block It Die”) with six sides comprised of red pips denoting numbers 2-6 with a red symbol embedded in replacing the number 1 pip as disposed on one facet. The symbol is the letter B. The game is played with two players, Player One and Player Two. Players take alternate turns to score points or block opponent's ability to score, with the goal of the game to be the first player to reach a predetermined score.

### CROSS-REFERENCE TO RELATED APPLICATIONS

This application claims the benefit of U.S. Provisional Application No. 62/374,405, filed on Aug. 12, 2016, the disclosure of which is incorporated herein by reference.

### BACKGROUND OF THE INVENTION

Traditional board games, while entertaining, may quickly become monotonous and boring. Some children resort to playing on a smartphone or tablet when they have tired of these games. Parents may desire that their children be more active and engaging rather than constantly using technology without interacting with others. The desire for a new interactive game lead to the invention of Block It.

### SUMMARY OF INVENTION

Block It is a new interactive dice game made for both indoor and outdoor use. The dice game varying in size and material for indoor and outdoor use comprises rules and three dice, two standard dice with six sides comprised of black pips denoting numbers 1-6, and a third die known as the Block It die (hereinafter known as the “Block It Die”) with six sides comprised of red pips denoting numbers 2-6 with a red symbol embedded in replacing the number 1 pip as disposed on one facet. The symbol is the letter B.

### BRIEF DESCRIPTION OF THE DRAWINGS

FIG. 1&2 illustrates a perspective view of the indoor game version comprised of two (2) standard dice, and a third (3rd) die known as the Block It Die having a symbol disposed on one facet replacing the number 1 pip. The symbol is the letter B. The dice are made of 20 mm thermoset plastic for travel convenience.

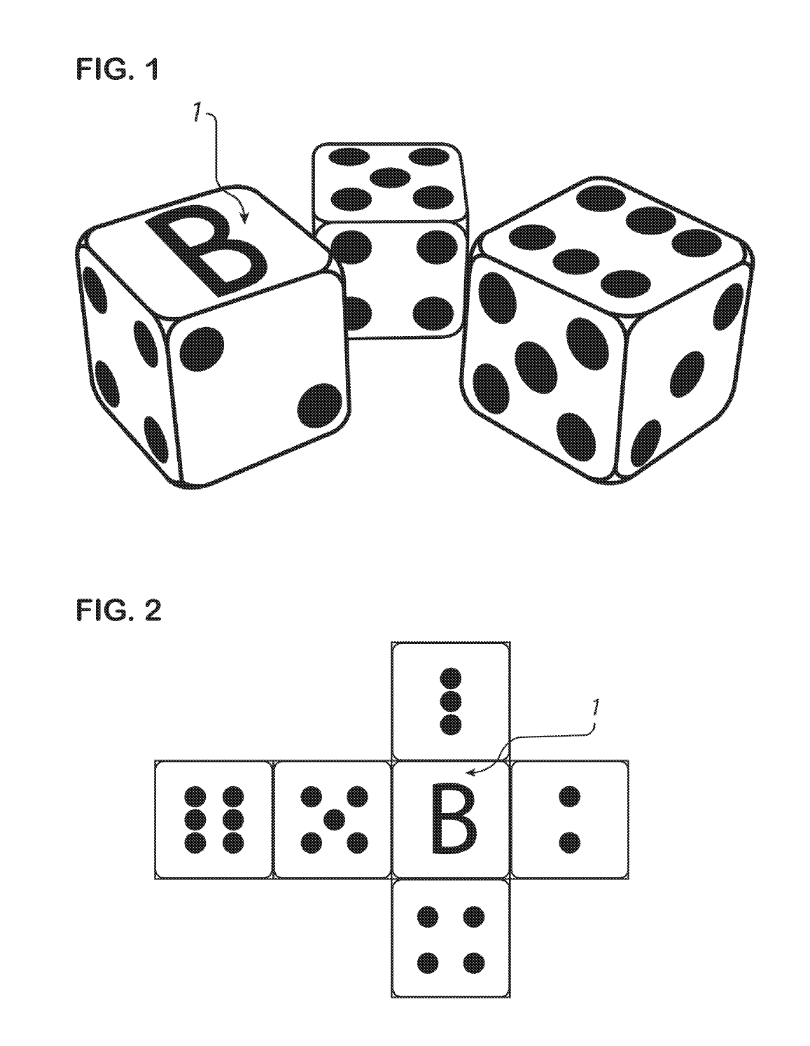

FIG. 3&4 illustrates a perspective view of the outdoor game version comprised of two (2) standard dice, and a third (3rd) die known as the Block It Die having a symbol disposed on one facet replacing the number 1 pip. The symbol is the letter B. The dice are made of 3.5″ Ethylene-vinyl acetate foam.

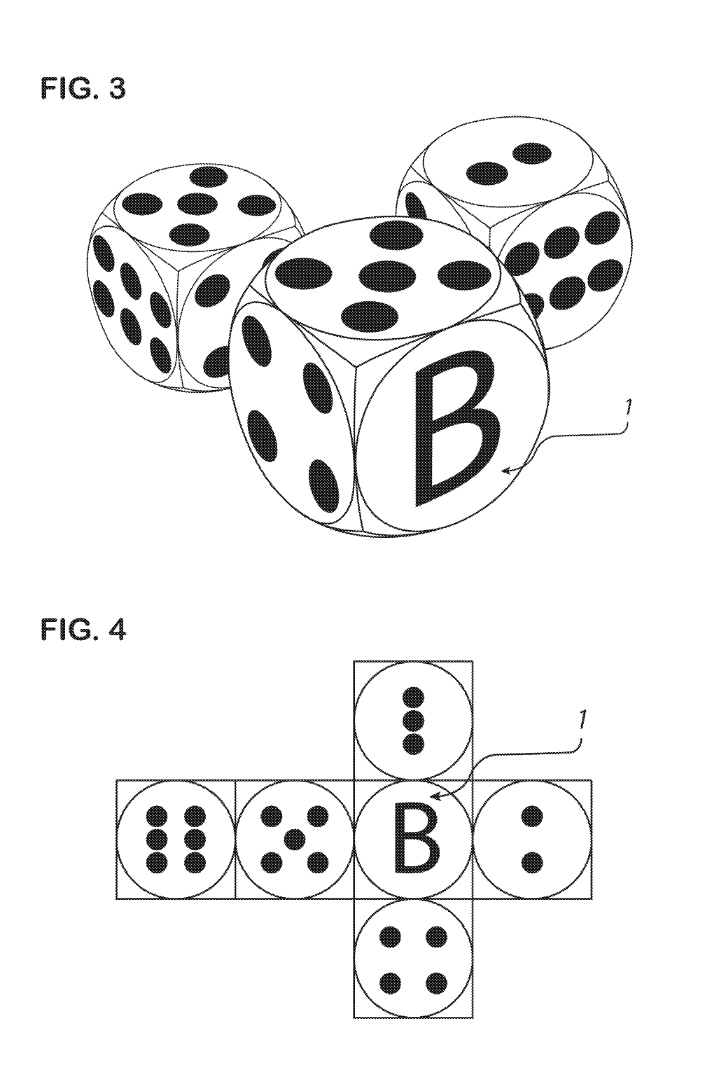

### DESCRIPTION OF INVENTION

A dice game varying in size and material for indoor and outdoor use comprised of the same rules and three dice; two standard dice with six sides comprised of black pips denoting the numbers 1-6, and a third die known as the Block It Die with six sides comprised of red pips denoting the numbers 2-6 and a red symbol embedded in replacing the number 1 pip as disposed on one facet. The red symbol is the letter B. The game is played with two players, Player One and Player Two.

To begin, each player will roll a standard die, setting aside the Block It Die. The highest number rolled will determine which player goes first with Player One having the highest number followed by Player Two with the lowest. To start the game, Player One should possess a standard die while Player Two possesses both a standard die together with the Block It Die. Player One will roll first using the standard die for points. Player Two is then afforded two attempts to block points of Player One by first using the Block It Die with the objective of rolling either a matching number or the letter B in an attempt to cancel out or block points of opponent. If successful, Player Two earns the ability to roll the standard die to score points which Player One will be unable to block in this first round. If unsuccessful, Player Two is then afforded one last attempt to roll a matching number in cancelling out points rolled by Player One using the standard die.

Example given. Player One rolls a 5 using the standard die. Player Two must then use the Block It Die to either also roll a 5 or the letter B in an attempt to cancel out or block Player One from scoring points.

If Player Two is successful in blocking points with the roll of matching number (5 in this example) or the letter B, Player Two then has the opportunity to roll his or her standard die to score points of which Player One will be unable to block in round 1. Whatever number Player Two happens to roll (4 for example), Player Two would receive those (4) points while Player One would earn 0 points since their points were blocked by Player Two's roll of a matching number or the letter B.

If Player Two is unsuccessful in blocking Player One with the roll of a matching number (5 in this example) or the letter B, Player Two will have one last opportunity to roll a matching number in an attempt to cancel out points using the standard die. If successful, Player One is blocked from receiving points with both Player One and Player Two earning 0 points in round 1. If unsuccessful, Player One is awarded points scored (5 in this example) while Player Two is awarded 0 points in round 1.

The round is now over with players switching roles and alternating turns. Player One will now possess both the Block It Die together with the standard die with Player Two rolling for points using the standard die. A scratch pad can be used to keep score. The first player to reach a predetermined score (as agreed upon by both Player One and Player Two) wins the game.

The foregoing descriptions of specific embodiments of the present invention have been presented for purposes of illustration and description. They are not intended to be exhaustive or to limit the invention to the precise forms disclosed, and obviously many modifications are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A dice game, comprising:
Die embedded with the letter B on one facet (herein referred to as the Block It Die) as ascribed under Description of Invention.

2. The dice game of claim 1, further comprising:
game rules and game objective in substantially the same form, content and art design as ascribed under Description of Invention.
